(19) United States
(12) Patent Application Publication
(10) Pub. No.: US 2006/0274527 A1
(43) Pub. Date: Dec. 7, 2006

(54) Apparatus for providing illuminated images associated with containers

(76) Inventor: Michael Langone, W. Springfield, MA (US)

Correspondence Address: MCHALE & SLAVIN, P.A., 2855 PGA BLVD, PALM BEACH GARDENS, FL, 33410, US

(21) Appl. No.: 11/229,001

(22) Filed: Sep. 16, 2005

Related U.S. Application Data
(60) Provisional application No. 60/687,372, filed on Jun. 4, 2005.

(51) Int. Cl. F21V 23/04

(52) U.S. Cl. 362/276

(57) ABSTRACT

A novelty illumination system for entertainment and advertisement uses icons which can be incorporated into a container for holding and dispensing drinks. The illumination system includes LEDs connected by a control circuit, energized by a switch and powered by a battery. The system may be placed on the outside or in the interior of a container lighting the icon and contents.

### FIELD OF THE INVENTION

This invention is directed to the field of containers and in particular, illuminated images that are associated with containers. Claiming priority of U.S. Provisional Application 60/687,372, the contents incorporated herein by reference.

### BACKGROUND OF THE INVENTION

The food and beverage business is highly competitive. Frequently, the only real difference between competing brands of a particular product is the product branding and packaging. For a product to be noticed in a crowded marketing world it must present a clearly discernible difference. In the case of distilled spirits or soft drinks, the decision to purchase one particular brand over another in a drinking establishment or restaurant is often made “on the spot” and immediately before the product is served. Some of the decision factors that are involved include printed advertisements, which may be posted in the area, electric signs (more common with beer products) special promotions, which may include give-away items and bar, or restaurant tabletop displays, which advertise particular brands.

Carefully designed bottle labels and bottles of unusual shape are additional methods used by marketers to help sell a particular brand of beverage. The appearances of the actual beverages themselves are normally unremarkable.

### DESCRIPTION OF THE PRIOR ART

Gindi, U.S. Pat. No. 6,588,435, and British patent GB239827, to Townsend, teach the use of LEDs mounted on or in containers, carrying cosmetics or perfume, and actuated by a touch or movement of the cap to illuminate the container.

Published Patent Application, Pub. No. US 2005/0056663 to Yu and Pub. No. US 2005/0083676 to VanderSchuit, teach the use of LEDs to illuminate cosmetic containers and labels on various articles, respectively. The LEDs are activated by manual switches.

U.S. Pat. No. 4,229,893 to Uys Naude and U.S. Pat. No. 6,409,046 to Peckels teach the use of a lighted pouring spout that illuminates when a drink is poured from a beverage container.

### SUMMARY OF THE INVENTION

Accordingly, it is a primary objective of the instant invention to provide an economical system to increase awareness of a particular beverage brand as a useful marketing aid.

It is a further objective of the instant invention to provide a system to draw attention to the product both before and after the product was served.

It is yet another objective of the instant invention to provide a system to impart illumination to the beverage being dispensed.

### BRIEF DESCRIPTION OF THE FIGURES

FIG. 1 shows an isometric view of one embodiment of the instant invention;

FIG. 2 shows an illuminated icon which resides in a “dry well” integral to a bottle;

FIG. 3 shows an illumination system of the device of the instant invention; and

FIG. 4 shows a drinking vessel with illuminated icon.

### DETAILED DESCRIPTION OF THE INVENTION

The instant invention provides an economical, and effective means to provide illumination of images or icons, which are associated with containers, and in particular to containers designed to hold translucent or transparent liquids such as beverages (including water), soaps and lotions. The device may provide illumination of printed, embossed, molded or other items or indicia either within or attached to these containers. The container may be of a fluid storage type such as a bottle which may be used for shipping and storage of liquids, or alternately, of a fluid dispensing type such as a drinking bottle, Martini shaker or lotion dispenser, or even a drinking glass. Throughout this document the terms container, vessel and bottle will be used interchangeably. In its simplest form, the device of the instant invention comprises a container with lighting means operatively coupled to a power source and activation means. Typically some or all of these components may be located entirely external to the fluid holding portion of the container. A portion of the components, and preferably those components which are to be illuminated may reside within the container, or at least appear to reside within the container, though these components may or may not be actually wetted by the contents of the container.

In one preferred form, an image such as a representation of a piece of fruit such as a lemon wedge is positioned within the container and is comprised of a transparent or translucent material such as plastic, glass or ice. A lighting means is operatively coupled to the icon in such a way that the icon appears to glow when the lighting means is activated. The process of “edge lighting” may be employed to permit light to be effectively coupled to the icon and distributed throughout the icon.

A figure representing a human form, an animal or mythical figure, a logo or any other icon may be illuminated in this manner. Selective etching or a process which otherwise alters the optical properties of the icon may be employed to cause light to be emitted from the icon in selected regions as may be desired.

In a second preferred form of the device of the instant invention, the image is positioned external to the container. Such an embodiment may take the form of a relatively thin label or other form in which the icon may be situated in close proximity and more or less conformal to the outer wall of the container. For example, an icon in the form of a thin, curved sheet of translucent plastic which is engraved, printed or otherwise decorated with the product dress of a particular brand of beverage may be provided. At least a portion of this icon is illuminated by a light source to which it is optically coupled. This coupling may take the form of an optical fiber or “light pipe.” Coupling may also be achieved by placing the lighting means in close physical proximity to the icon itself and preferably, in a manner whereby light emitted by the lighting means is focused or otherwise concentrated so that it is effectively coupled to the icon. Depending on the relative position of the icon to the fluid in the vessel, a portion of the light emitted by the icon may also be transmitted to the fluid thereby causing the fluid to appear to glow as well.

While the light generating means may employ any suitable device, at least one LED is preferred since LEDs are compact, rugged and energy efficient. Additionally, LEDs are available in virtually all colors, as well as ultraviolet. It is anticipated that the light source may be capable of generating a plurality of colors such as may be generated by a multicolored LED which colors may be controlled by an electronic circuit. Further, the light source may be steady or caused to flash or pulse in an interesting manner. A single color light source could also be employed. It is further anticipated that an ultraviolet LED could be employed to cause fluorescent materials, such as the icon, the container, the container label or the product to be dispensed, to glow.

Activation means may comprise a contact closure that is triggered when the bottle is inverted during the pouring process. One suitable switch for this application consists of a small metal ball in a tube that provides a contact closure when properly oriented. Alternately, a switch may be devised which causes the system to be activated when the container is lifted from a surface upon which it is resting.

Further activation means may include a mechanical motion switch, a touch activated switch, a pressure activated switch, spring biased switch or a liquid contact switch. The activation means listed are for illustrative purposes and should not be interpreted as limiting.

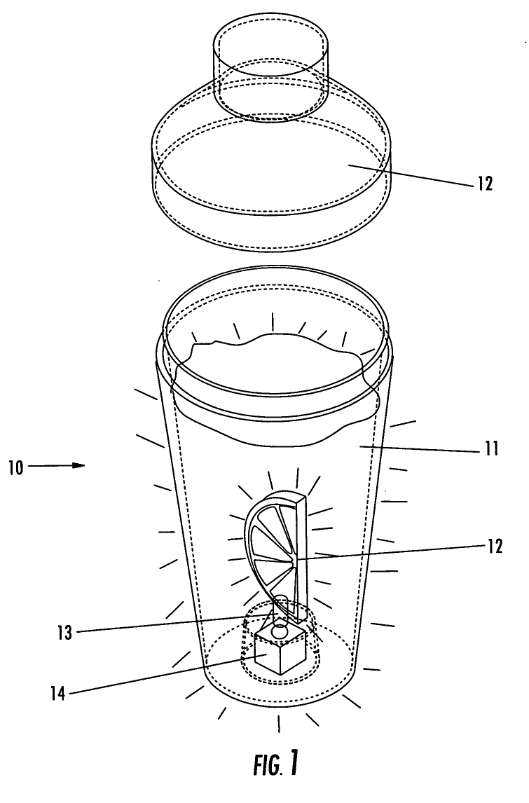

Now, referring to FIG. 1, a device with an illuminated icon 10 has a container 11 to which is attached a illuminated icon 12. Optical fiber(s) 13 may be employed to transmit optical energy from illumination system 14 to icon 12. Icon 12 may be etched, inscribed with indicia or otherwise designed to selectively emit light as may be desired. Icon 12 may be constructed of a clear or translucent thermoplastic resin, glass, ice or any other suitable light transmissive material. Icons may be either removably or non-removably mounted to container 11. Alternately, the icon may actually be a component of the container itself which may be formed simultaneously with the formation of the container.

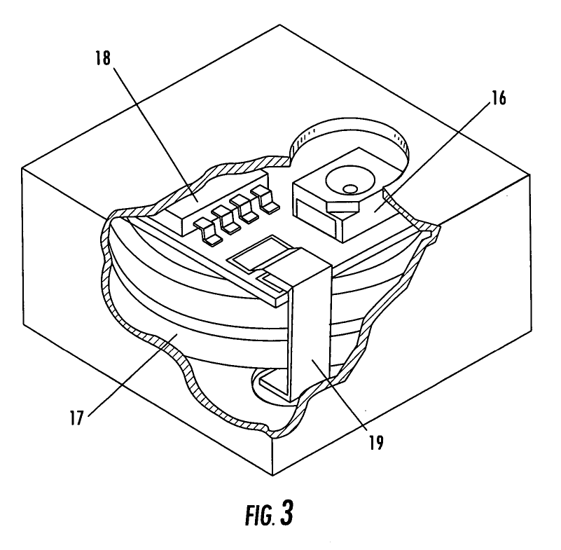

The illumination system 14 is shown in FIG. 3. While any suitable means of illumination may be employed, typically, a light source 16 such as LED or incandescent lamp if operatively coupled to a power source 17. Power source 17 may comprise at least one battery. Optionally, electronic circuit 18 may be employed to switch, modulate or otherwise control power from power source 17 to the light source, 16. Activation switch 19 may be employed to cause the device to activate when desired. Activation switch 19 (shown here as normally open, push button type switch) completes the electrical circuit when the container is lifted from a surface, thereby causing light source 16 to produce light.

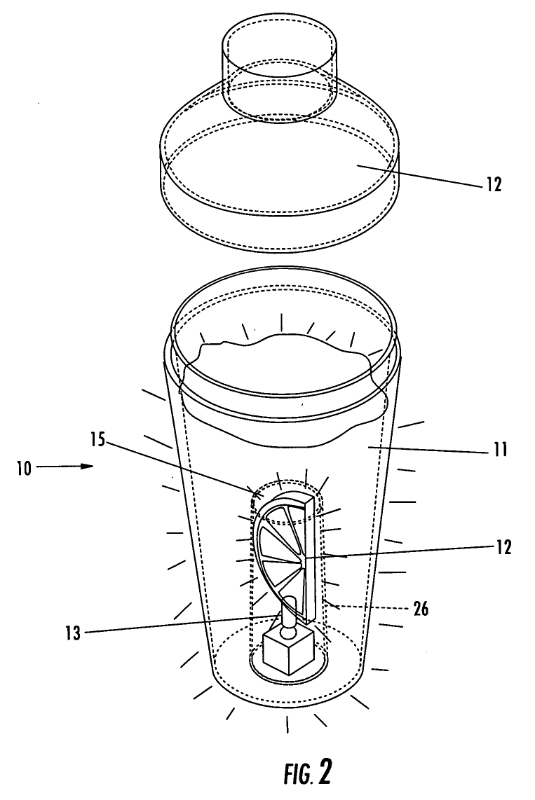

A substantial portion of this light is coupled through light pipe 13 and is transmitted to icon 12 whereupon the icon glows and is visible. Light pipe 13 may not be required if icon 12 is to be located physically close to light source 16. The container shown in FIG. 2 incorporates a dry well 15. This well, comprises a enclosure 26 which extends into the central region of the container. A container with this design permits illumination system 14 to be positioned in the central region of the container without exposing any of the components of the illumination system to any fluid that might be in the container.

A control circuit 18 as shown in FIG. 3 may be provided which employs any known means such as a micro-control unit, micro-chip, or other suitable circuit to interrupt, modulate or otherwise control the flow of energy from power source 17 to light source 16 randomly or in a pattern.

Activation switch 19 may be a manual switch or other sensing device that triggers or otherwise controls action of electronic circuit 18 and thereby energizes light generation by light source 16. Light source 16 may employ any suitable light generating means but is preferably at least one light emitting diode (LED). Light source 16 may comprise a plurality of lights, such as LEDs of multiple colors, for example, red, blue and green. Control of the relative apparent brightness ratios of these LEDs permits generation of an infinite variety of colors. Relative brightness may be controlled either by direct current control or by pulse width control as may be achieved by the electronic control circuit.

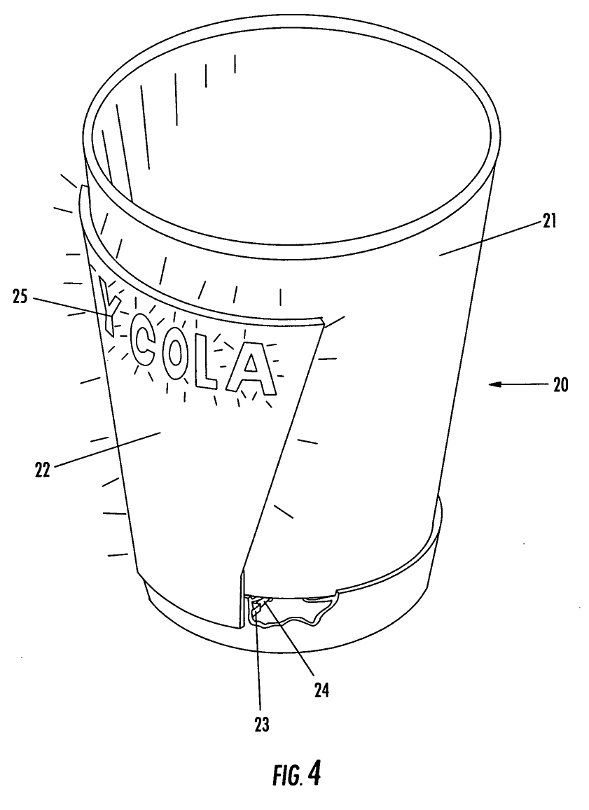

An alternate embodiment of the instant invention is illustrated in FIG. 4. In this embodiment, container with icon 20, comprises a drink glass 21 which is outfitted with icon 22 which may incorporate fiber optic(s) 23 to couple light from light source 24. Indicia 25 produced by molding, etching, engraving, printing or any other suitable means is illuminated by light coupled from light source 24 and disseminated in icon 22. The icon 22 may be separate from the glass 21, such as a coaster, and the switch may activate by removing the glass from the coaster. Illumination could be either when the glass is in contact with the coaster or when it is separate. Alternatively, the icon 22 and glass 21 may be one piece with the switch being on the bottom so that it is activated by removing the drink from its support (table).

The instant invention then provides for illuminated icons, labels or other figures which appear to be suspended within the fluid holding portion of a container or alternately, positioned proximal to a surface of the container. The effect of these illuminated icons is striking and calls attention to the container and whatever product it contains. Such a device could find useful application as an aid to the marketing of beverages or other fluid such as shampoos, lotions or other products.

It is understood that the product of the instant invention can be used in any number of other ways and that the exact embodiments are not limited to those illustrated here.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

I(We) claim:

1. A novelty drink holder for entertainment and advertisement comprising a container having continuous sidewalls defining an interior and an open mouth connected to said interior, at least one icon intimately associated with said sidewalls, an illumination system attached to said container and oriented to illuminate said icon, said illumination system including a power source, at least one LED connected by a control circuit, and a switch operatively connected to said control circuit and said container whereby said icon is illuminated when said switch is activated.

2. A novelty drink holder of claim 1 wherein an enclosure is disposed in said interior surrounding said illumination system whereby said illumination system is separated from said interior.

3. A novelty drink holder of claim 2 wherein said icon is disposed within said enclosure.

4. A novelty drink holder of claim 2 wherein said enclosure surrounds said power source, said at least one LED and said control circuit.

5. A novelty drink holder of claim 2 wherein said container and said enclosure are one piece.

6. A novelty drink holder of claim 2 wherein said icon and said at least one LED are connected by a fiber optic.

7. A novelty drink holder of claim 2 wherein said illumination system is composed of a plurality of LEDs.

8. A novelty drink holder of claim 7 wherein said control circuit energizes said plurality of LEDs in a pattern.

9. A novelty drink container of claim 7 wherein said plurality of LEDs produce different colors.

10. A novelty drink holder of claim 1 wherein said sidewalls are disposed intermediate said icon and said interior.

11. A novelty drink holder of claim 10 wherein said illumination system is housed in said icon.

12. A novelty drink holder of claim 10 wherein said container and said icon are one piece.

13. A novelty drink holder of claim 10 wherein said icon and said at least one LED are connected by a fiber optic.

14. A novelty drink holder of claim 10 wherein said illumination system is composed of a plurality of LEDs.

15. A novelty drink holder of claim 14 wherein said control circuit energizes said plurality of LEDs in a pattern.

16. A novelty drink container of claim 14 wherein said plurality of LEDs produce different colors.
